(19) United States
(12) Patent Application Publication
(10) Pub. No.: US 2023/0401689 A1
(43) Pub. Date: Dec. 14, 2023

(54) WEAR MEMBER MONITORING SYSTEM

(71) Applicant: Bradken Resources Pty Limited, New South Wales (AU)

(72) Inventors: Daniel Jonathon FARTHING, New South Wales (AU); Reece ATTWOOD, New South Wales (AU); Glenn BAXTER, New South Wales (AU); Adam AMOS, New South Wales (AU); Oliver BAMFORD, New South Wales (AU); Sam FARQUAHR, New South Wales (AU)

(73) Assignee: Bradken Resources Pty Limited, New South Wales (AU)

(21) Appl. No.: 18/033,982

(22) PCT Filed: Oct. 26, 2021
(86) PCT No.: PCT/AU2021/051244

§ 371 Date: Apr. 26, 2023

(30) Foreign Application Priority Data
Oct. 26, 2020 (AU) 2020903877
Aug. 25, 2021 (AU) 2021221819

(51) Int. Cl. G06T 7/00; G06T 7/70; G06T 15/20; E02F 9/26

(52) U.S. Cl. CPC G06T 7/0004; G06T 7/70; G06T 15/205; E02F 9/267; G06T 2207/10012; G06T 2207/10028; G06T 2207/10048; G06T 2207/30164

(57) ABSTRACT

Disclosed is a system and method for determining a wear or operational characteristic regarding an apparatus. The method includes: determining a position data of at least a portion of the apparatus, by analysing two-dimensional image data from each of a plurality of image sensors located to capture image data of the apparatus, or part thereof, and calculating a physical or operational characteristic using the position data.

### CROSS-REFERENCE TO RELATED APPLICATIONS

This application is a national stage application under 35 USC 371 of International Application No. PCT/AU2021/051244, filed Oct. 26, 2021, which claims the priority of Australian Application No. 2020903877, filed Oct. 26, 2020 and Australian Application No. 2021221819, filed Aug. 25, 2021, the entire contents of each priority application of which are incorporated herein by reference.

### FIELD OF THE DISCLOSURE

This disclosure relates to a system and method of monitoring equipment operation and condition, using parameters obtained from images taken of the equipment. Examples of application include but are not limited to the monitoring of wear in wear members in equipment, in particular heavy equipment used in mining, and/or excavation.

### BACKGROUND OF THE DISCLOSURE

Wear members are provided on the digging edge of various pieces of digging equipment such as the buckets of front end loaders. The wear assembly is often formed of a number of parts, commonly a wear member, a support structure and a lock. The support structure is typically fitted to the excavation equipment and the wear member fits over the support system and is retained in place by the lock. In some instances, one or more intermediate parts may be also included between the wear member and the support structure. For ease of description it is to be understood that, unless the context requires otherwise, the term “support structure” used in this specification includes both the support structure arranged to be fitted to, or forming an integral part of, the excavation equipment or, if one or more intermediate parts are provided, to that intermediate part(s) or to the combination of the support structure and the intermediate part(s).

The reason that the wear assembly is formed of a number of parts is to avoid having to discard the entire wear assembly when only parts of the wear member, in particular the ground engaging part of the wear assembly (i.e. the wear member) is worn or broken.

The condition of the wear member is inspected or monitored to identify or anticipate any need for replacement of the wear assembly. Monitoring of other operation conditions of the wear assembly or the equipment itself is also desirable. For example this allows the maintenance or replacement work to be timely carried out or planned.

This inspection typically involves stopping the operation of the machine so that an operator can perform a visual inspection. Such inspection requires costly down time, and as a result, cannot be done frequently. If an imminent loss is detected, further down time may be required for the repair or replacement parts to be ordered.

There are existing systems that try to automate this inspection process by acquiring images of the wear assembly and analysing the pixel values corresponding to the teeth, or performing edge analyses to detect edges of the teeth, to identify losses.

It is to be understood that, if any prior art is referred to herein, such reference does not constitute an admission that the prior art forms a part of the common general knowledge in the art, in Australia or any other country.

### SUMMARY OF THE DISCLOSURE

In an aspect, disclosed is method for determining a physical or operational characteristic regarding an apparatus. The method includes determining a three dimensional model of the monitored apparatus from stereo image data acquired of the apparatus, and then calculating a physical or operational characteristic using the three dimensional model.

In an aspect, disclosed is method for determining a physical or operational characteristic regarding an apparatus. The method includes: determining a position data of at least a portion of the apparatus relative to two or more image sensors located to capture image data of the apparatus, or a portion thereof, by analysing two-dimensional image data output by at least two of the image sensors; and calculating a physical or operational characteristic using the position data.

The method can include using the position data to construct a three-dimensional model of the apparatus.

The method can include comparing data from the constructed model with data from a known model of the apparatus.

The constructed model can be a three-dimensional point cloud or a mesh model.

The method can include providing one or more visual targets to the monitored apparatus, the one or more visual targets being configured so that they are detectable in the image data.

The targets may be mechanical components attached to the apparatus. For example, the targets may be dual nuts.

The targets may be arranged in a pattern which is detectable using image processing algorithms from the image data.

The method may comprise detecting the one or more targets in the image data, and comparing the image data of the targets with expected image data of the targets when the apparatus is at a reference position and/or reference orientation.

The method may comprise determining a position and orientation of the apparatus based on the above-mentioned comparison.

The method may comprise transforming a coordinate system for the three dimensional model based on the determined position and/or orientation.

The physical or operational characteristic can be or can be determined from at least one distance, area, or volume measurement calculated using the position data.

The method can include comparing the calculated at least one distance, area, or volume measurement against a predetermined value.

The physical or operational characteristic can include a physical measurement, or an operational parameter.

The method can include storing a plurality of physical or operational characteristics determined over time.

The method can include predicting a service or maintenance requirement for the apparatus on the basis of the plurality of physical or operational characteristics determined over time.

The method can include using the plurality of physical or operational characteristics to determine a physical or operational profile of the apparatus. The profile can be a historical or statistic profile of the physical or operational characteristic.

The at least one physical or operational characteristic can include a payload volume of the apparatus.

The at least one physical or operational characteristic can provide a measure of deterioration, loss or damage to the apparatus.

The at least one physical or operational characteristic can include a wear characteristic.

The apparatus can be a wear component.

The apparatus can be the wear component of a mining equipment.

The imaging sensors can be mounted under a boom arm of the mining equipment.

The physical or operational characteristic can include a physical measurement or an operational parameter.

The method can include obtaining a two-dimensional thermal image of the apparatus.

In embodiments where the position data are used to generate the three dimensional model, the method can include assigning thermal readings in the two-dimensional thermal image to corresponding locations in the three-dimensional model, to create a three-dimensional heat map.

The method can include identifying a location of loss using the three-dimensional heat map.

In a second aspect, disclosed is a method for determining a physical or operational characteristic regarding an apparatus, comprising combining a thermal image of the apparatus, or a part thereof, with a three-dimensional model of the apparatus, or the part thereof, to create a three-dimensional heat map; and obtaining a physical or operational characteristic using the three-dimensional heat map.

The thermal image can be a two dimensional thermal image.

The apparatus can include a ground engaging tool, and the method comprises using the three-dimensional heat map to identify a worn or lost portion of the ground engaging tool.

The ground engaging tool can be an earth digging tool.

The method can include determining an orientation of the apparatus, relative to a reference direction, wherein the at least one physical measurement or operational parameter is adjusted to compensate for the orientation of the apparatus.

The reference direction can be a horizontal direction or at an angle to the horizontal direction.

In a further aspect, disclosed is a system for assessing a wear or operational characteristic of an apparatus, the system comprising: a plurality of imaging sensors each configured to acquire an image of the apparatus, or part thereof; a computer readable memory for storing the image data of the acquired images; and a computing device comprising a processor, the processor being in data communication with the computer readable memory. The processor is configured to execute computer readable instructions to implement the method mentioned in the previous aspects.

The system can include a thermal sensor, collocated with at least two of the image sensors.

In a further aspect, disclosed is an image sensor assembly for capturing a physical or operational characteristic regarding an apparatus, including at least two image sensors which are spaced part from each other and located within a housing, the image sensors being adapted to capture image data of the apparatus, or part thereof, and a thermal sensor.

The thermal sensor can be located between the at least two image sensors and within the housing.

In a further aspect, disclosed is a mining or excavation equipment having an image sensor assembly mentioned in the above aspect mounted thereon.

The image sensor assembly can be mounted on a boom arm of the mining or excavation equipment.

### BRIEF DESCRIPTION OF THE FIGURES

Embodiments will now be described by way of example only, with reference to the accompanying drawings in which

FIG. 1 is a schematic depiction of a system for monitoring and assessment of an apparatus, in accordance with an embodiment of the current disclosure;

FIG. 2 is a schematic depiction of an image processing to obtain depth data of a monitored apparatus;

FIG. 3 is a schematic depiction of an image processing to obtain a three dimensional model of the monitored apparatus;

FIG. 4 is a partial side view of a mining equipment having a bucket which is being monitored using the present system, depicting a calculation of an angular pose of the bucket;

FIG. 5 is a schematic depiction of another system for monitoring and assessment of an apparatus, which includes utilisation of thermal image data;

FIG. 6 is a heat map of an excavation bucket, showing a tooth loss;

FIG. 7 is a perspective view of a bucket, overlaid with data points and measurements used to calculate a payload of the bucket;

FIG. 8-1 is a perspective view of a mining equipment having an excavation bucket, showing possible locations for mounting image sensors to capture stereo image data of the bucket;

FIG. 8-2 are views of the bucket captured by image sensors mounted at each location shown in FIG. 8-1;

FIG. 9 is a conceptual representation of the system to assess an apparatus;

FIG. 10 is an example workflow to identify the monitored apparatus from image data, in accordance with an embodiment of the disclosure;

FIG. 11 is a perspective view conceptually depicting a front face model to be aligned to the point cloud of a bucket of a ground engaging tool;

FIG. 12 is a partial perspective view of a bucket of a ground engaging tool, showing the three-dimensional offsets between a point on a tooth on the bucket and a point on the mouth of the bucket;

FIG. 13 is a partial perspective view of a bucket of a ground engaging tool, conceptually depicting a plane created using point cloud data to represent the base of a tooth on the bucket;

FIG. 14-1 is a partial perspective view of a bucket of a ground engaging tool, conceptually depicting a plane created using point cloud data to represent the mouth of the bucket;

FIG. 14-2 is a partial perspective view of a bucket of a ground engaging tool, conceptually depicting a pyramid formed by a point representing the highest point on the payload pile and the plane shown in FIG. 14-2, for calculating an estimate of the payload volume;

FIG. 15-1 is a schematic depiction of a monitored apparatus with targets attached to corner points of the apparatus;

FIG. 15-2 is a schematic depiction of a monitored apparatus with targets attached to a side of the apparatus, where the targets form a line;

FIG. 15-3 is a schematic depiction of a monitored apparatus with targets attached to a side of the apparatus, where the targets form a square.

### DETAILED DESCRIPTION

In the following detailed description, reference is made to accompanying drawings which form a part of the detailed description. The illustrative embodiments described in the detailed description and depicted in the drawings, are not intended to be limiting. Other embodiments may be utilized and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

Herein disclosed is a system and method for monitoring of an equipment using stereo vision, so as to determine one or more physical measurements or operational parameters of the equipment. This enables an assessment or monitoring of the physical condition (i.e., to determine a wear, damage, or loss of a physical part), performance, or operation of the equipment. This allows further assessment and planning of the repair or maintenance needs of the equipment. An assessment of the operational parameters of the equipment is also useful for project planning and resource allocation.

In relation to the physical condition of the equipment, an application of the disclosed system is to determine data to indicate wear. Here, the term “wear” broadly encompasses gradual deterioration, any physical damage, or total loss, of any part of the monitored apparatus. The term “wear profile” therefore may encompass a historical, or physical profile of the manner in which the monitored apparatus or equipment has worn or is wearing. This may encompass a rate or other statistic, or information regarding, the extent and location of the gradual deterioration, physical damage, or total loss. Similarly, the term “operational profile” can refer to a historical, or statistical profile of an operation of the apparatus.

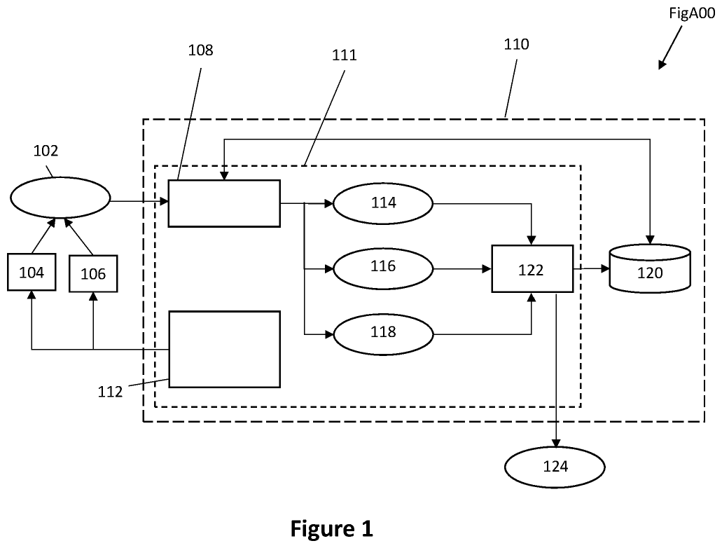

FIG. 1 schematically depicts a system 100 for the monitoring and assessment of a monitored apparatus 10 (not shown) using stereo image data. In the depicted example, the system 100 makes use of image data 102 of a set of two-dimensional images. The images are each acquired by one of a set of cameras 104, 106, positioned to capture stereo images of the equipment or component of the equipment which is being monitored. The cameras 104, 106 may be mounted on the equipment itself, on a part which is not being monitored, to capture in their fields of view the component or part being monitored.

The system 100 comprises an image processing module 108 which is configured to receive the image data 102 or retrieve the image data 102 from a memory location, and execute algorithms to process the image data 102. In some embodiments, the monitored apparatus 10 is part of an equipment or machinery, and the image processing module 108 resides on a computer 110 which is onboard the equipment or machinery. There is preferably a data communication, either via a wired cable connection or a wireless transmission, between the cameras and the computer 110. In other embodiments, the computer is located remote from the monitored apparatus 10.

In either scenario, the system 100 may include a control module 112 which is preferably adapted to provide control signals to operate the cameras. In such embodiments, the communication between the computer 110 and the cameras can be further bi-directional for the control module 112 to receive feedback. The control signal(s) may be provided per operation cycle of the monitored apparatus 10. For example, this ensures there are at least two images with a sufficient view of the monitored apparatus or part thereof, per digging and dumping cycle in the case of a ground digger, such that the image captured of the monitored apparatus will provide sufficient information for the processing to obtain the performance or operational estimates or parameters, such that the monitoring or assessment of the apparatus can be done. Alternatively, or additionally, control signals may be provided to operate the cameras at regular time intervals or at any operator selected time. The control module 112 and the image processing module 108 are typically implemented by a processor 111 of the computer 110. However, they can be implemented by different processors in a multi-core computing device or distributed across different computers. Similarly, the processing algorithms, which are executed will typically reside in a memory device collocated with a processor or CPU adapted to execute the algorithms, in order to provide the processing module 108. In alternative embodiments the algorithms partially or wholly reside in one or more remote memory locations accessible by the processor or CPU 111.

Prior to being provided to the computer to be processed, the images may be pre-processed in accordance with one or more of calibration, distortion, or rectification algorithms, as predetermined during the production and assembly process of the stereo vision cameras. The pre-processing may be performed by the processing module 108, or by a built-in controller unit provided in an assembly with the cameras 104, 108. Alternatively, the raw images will be provided to the computer where any necessary pre-processing will be done prior to the image data being processed for monitoring and assessment purposes.

The image processing module 108 is configured to process the image data 102 to obtain a depth data 114 of the monitored apparatus in relation to the cameras 104, 106, the depth data representing the distance of the monitored apparatus from the cameras 104, 106. The depth data, matched or co-registered with the position data in the two-dimensional (2D) coordinate system, provide a three-dimensional (3D) point cloud.

It will be appreciated that the exact algorithm for creating a 3D data using the stereo image data does not need to be as described above, and can be devised by the skilled person.

By reviewing the coordinate values of the point cloud at various locations, e.g., features or landmarks, on the monitored apparatus, a pose information 116, including orientation and position information of the monitored apparatus 10 can also be calculated. For instance, this may be obtained by calculating an angle formed between two landmark points, in relation to a reference direction such as the horizontal direction. The landmarks used for the pose calculation are preferably, or are preferably located on, components which are expected to be safe from wear or damage. For example, in the case that the monitored apparatus is the bucket of a ground engaging tool, the landmarks can be provided by dual nuts or other mechanical elements bolted or welded onto the bucket, or by other visual elements which may simply be painted on the bucket, or the target(s) may be directly formed onto the bucket. The “landmarks” or “targets” may be provided with a distinctive pattern, or may be provided in a colour or with a reflectivity which provides a contrast with the surface to which they are attached, to help make them detectable in the image data.

Further, dimensional measurements 118 of the monitored apparatus 10 can be obtained. The dimensional measurements 118 are distances along particular lengths or thicknesses of the monitored apparatus 10. The distance can be calculated by determining the distance between 3D data points lying on these lengths or thicknesses, compensated for the orientation and position of the monitored apparatus in the images. The distances being determined may correspond with distances between particular 3D data points which are ascertained to correspond to the landmarks.

The captured image data 102, or the depth data 114, and any orientation information 116 or dimension measurements 118 generated by the processing module 108, or both, may be stored in a memory location 120 for storage. These data are provided to an analysis module 122 for further analysis, either before or after they are stored. Analyses are performed include, but are not limited to, determining whether there has been any wear or loss in the monitored apparatus, and optionally analysing historical losses or wear, or predicting possible future loss or wear, or both. The analysis result may also be stored in the memory location 120.

The memory location 120 can be collocated with the computer 110 as depicted, or it could be a removable drive. Alternatively, the data will be sent to a remote location or to a cloud-based data storage.

The aforementioned data may be stored in separate locations. For instance, the captured image data and data from the image processing module may be stored separately from the analysis results. Transmission of the acquired data, processing results, or analysis results, may be done periodically, to sync it to a remote or cloud-based storage location.

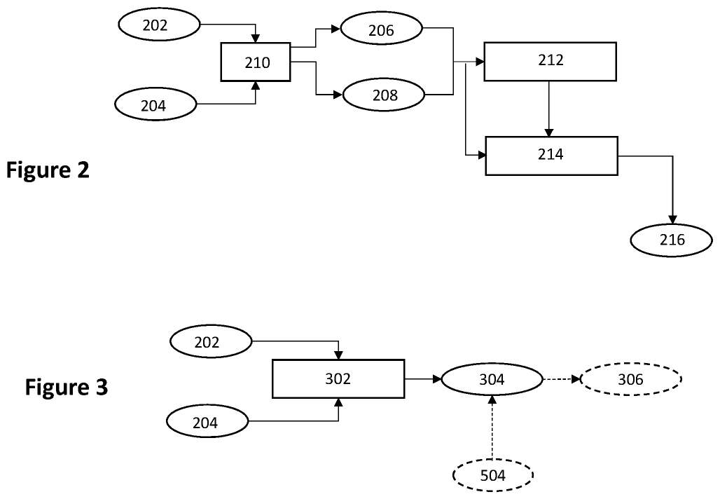

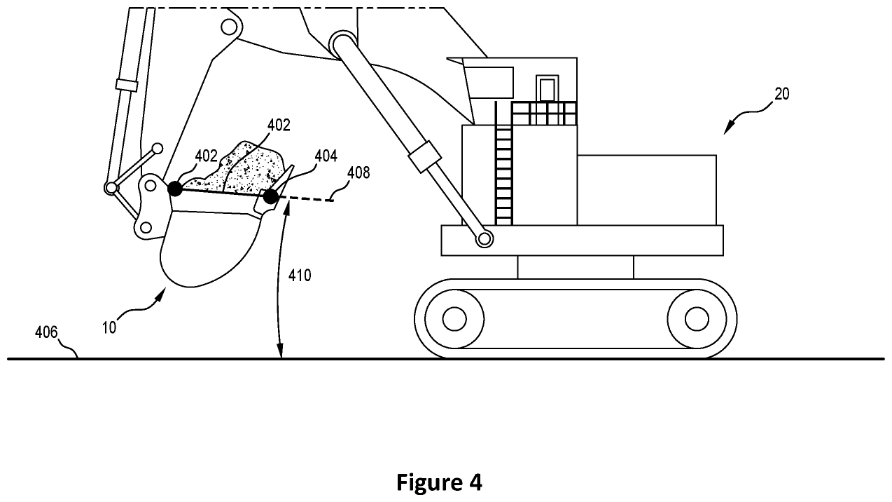

An embodiment of the processing 200 done by the image processing module 108 to produce the depth data 114, pose data 116, and dimensional measurements 118, is discussed further with reference to FIG. 2, FIG. 3, and FIG. 4.

As shown in FIG. 2, the images 202, 204 are processed by a feature detection algorithm 210 to detect one or more known features in the images. As aforementioned these can be landmark features on or provided to the apparatus, and which preferably are relatively protected from wear or damage, in comparison to the wear components. These parts should also be observable from both cameras so that they are present in both images.

The feature detection process 210 may comprise segmenting the images to create segmented images, which can be a foreground-background segmentation. The feature detection process 210 may additionally or alternatively comprise edge detection algorithms to create edge images. Other algorithms to detect the features in accordance with particular criteria, e.g., on the basis of expected profiles of the landmarks, may be used. Additionally or alternatively, the feature detection process 210 can rely on a detection module that has been configured or trained to recognise the particular apparatus or particular features in the apparatus being monitored.

Optionally, if the feature detection algorithm 210 does not detect the apparatus, or part thereof, being monitored, it will provide a communication indicating this finding to the control module 112 (see FIG. 1), to cause cameras to attempt image acquisition again. The newly acquired images can then be processed by the algorithm 210 again, and if they are determined to sufficiently capture the monitored apparatus 10, the feature images generated will be provided for further processing. Alternatively, the control module 112 may simply opt to wait for the data which will be acquired at the next scheduled image acquisition.

The detected features 206, 208, respectively found in the two images 202, 204 are matched to each other, to find a positional offset for each detected feature between the two images. The detected features 206, 208 may be provided on respective feature maps, one generated from a respective one of the images. This process is referred to as a correspondence step, performed using a correspondence module 212, to register a correspondence. This process matches the features from one image with the same features in the other image. As will be expected from stereo vision, the matched features captured in the two images will occupy differently located pixels in the two images, i.e., appear to have an offset in relation to each other.

The processing algorithms 200 include a depth determination process 214, which calculates the amount of offset between the two images, at pixel locations corresponding to the detected feature(s). The correlation between disparity as measured in pixels and actual distance (e.g., metres, centimetres, millimetres, etc) will depend on the specification of the cameras used, and may be available to the image data process as a calibrated setting data. The offset data and the calibration setting are then used to calculate a distance information of the monitored apparatus from the cameras. This results in a 3D data pair, being (x, y, depth), associated with each 2D pixel at location (x, y). The collection of the 3D data points provide a “depth map” 216, essentially a 3D point cloud.

Depth in relation to entire monitored apparatus may be calculated this way, or using other depth calculation algorithms in stereo image processing.

Alternatively, position and distance information are determined in respect of one or more detected features or landmarks of the monitored apparatus. This information may then be further be used to deduce position information of other parts of the monitored apparatus, whose positional relationship relative to the detected feature(s) is known, from the structure or profile of the apparatus being known from a reference model.

Knowledge of the 3D position data in relation to the detected feature(s) provides information in relation to the position (including location and orientation) of the monitored apparatus. In all embodiments, the position data can be relative to the image sensors rather than an absolute position. If the absolute position of the image sensors is known from, e.g., a global positional system or another positioning method, absolute position data of the detected features can be determined.

The image processing algorithm 200 is further configured, using the 3D data 216, to determine dimensional measurements 118, in one dimension (distance), two dimensions (area or surface), or three dimension (volume), of at least a part of the monitored apparatus or in relation to an operational metric of the apparatus. The dimensional measurements 118 can be obtained or calculated directly using the coordinate values of the 3D data points (i.e., point cloud). Alternatively, the system may generate a 3D model of the monitored apparatus using the 3D data points. As shown in FIG. 3, in some examples, the image processing algorithm 200 further includes a mesh model process 302. The mesh model process 302 is one way of using the image data 202, 204 to construct a three-dimensional model 304, but does not need to be used to utilised in all embodiments.

In one implementation, the model 302 is a mesh model comprising a plurality of mesh elements, each having at least three nodes, where adjacent elements share one or more nodes. In one example, the points in the depth map 216 are taken as nodes, and surface elements, such as triangular elements, are “drawn” between the nodes to model the surface. The properties of the model elements, e.g., mesh elements, such as the positions of the mesh nodes, distance between mesh modes, or areas covered or bound by the mesh elements, can be calculated to provide different metrics associated with the monitored apparatus.

More generally, using the positional data obtained, it is possible to derive the orientation or pose of the monitored apparatus. This is pictorially represented in FIG. 4, in which the monitored apparatus 10 is a bucket secured to an excavation equipment 20. The features identified here are two end points 402, 404 along one edge 403 of the mouth of the bucket 10. Other points such as those located on the front face of the bucket 10 bolted to the front face of the bucket 10, may be used.

Using the positions of the two points relative to each other, it is possible to estimate the angle of the edge 403, in relation to a reference line or direction 406. The reference can be the horizontal direction, and the angle 410 is that between the line 408 (represented as a dashed line) connecting the end points 402, 404, and the reference line 406. The calculated angle 410 is, or is used to derive, an orientation or pose data 116 for the monitored apparatus 10.

In the above, the features or “points” to be identified in the image data can be visible targets or markers which are provided on or secured to the monitored apparatus 10, which can be detected in the image data using image processing algorithms. The reference information is the known positions or an available image of those targets or a pattern or line formed by the targets, taken when the monitored apparatus has a known pose (orientation and position).

The positions of the points in the 3D point cloud corresponding to detected line or pattern, in comparison with the expected reference, will provide the pose information.

Where used, the visible targets may be chosen to facilitate their detection in the image data. For example, they may be each be chosen to have a distinctive pattern, such as a concentric target. The manner in which the multiple targets are arranged also preferably facilitate image processing. For example, the targets can be arranged in a linear line or in any other pattern, preferably easily detectable using image processing techniques.

Referring back to FIG. 1, and as alluded to above, the information which is generated by the processing module 108 will be provided for analysis by an analysis module 122, implemented by execution of one or more analytics algorithms. For instance, the analysis module 122 may be adapted to these measurements can be compared with the sizes or dimensions which the monitored apparatus is expected to have when it is in a new or undamaged state, to identify locations and amounts of component loss or damage. The information can be provided to an administrator, as a report or a notification 124 that there is sufficient damage or wear such that a repair is needed or should be scheduled. The dimensional measurements 118 may also be calculated more than once, so that measurements obtained at different times can be compared with each other, to ascertain a rate of wear, or more generally, to analyse the amount of wear or change over time.

The analysis module 122 may also determine an operational parameter or characteristic for the monitored apparatus. For example, in some embodiments, the monitored apparatus 10 is of a type that supports a volume or a payload—such as the bucket for a digger. Images taken of the monitored apparatus 10 during an operation cycle may thus also include image data in relation to the payload. Thus, the depth data 114, pose data 116, and dimension measurements 118 may also include information associated with the payload. This information can be used to calculate or estimate the payload volume for each operation cycle.

In some embodiments, the system further makes use of thermal imaging, in conjunction with the image data. This is particularly useful if at least a part of the monitored apparatus is expected to have a temperature differential compared to the remainder of the apparatus, or to the surrounds. In the example where the monitored apparatus is the bucket of a digger, the ground engaging tools on the bucket can be expected to heat up in the course of digging, e.g., to temperatures in the range of 60 degrees to 100 degrees.

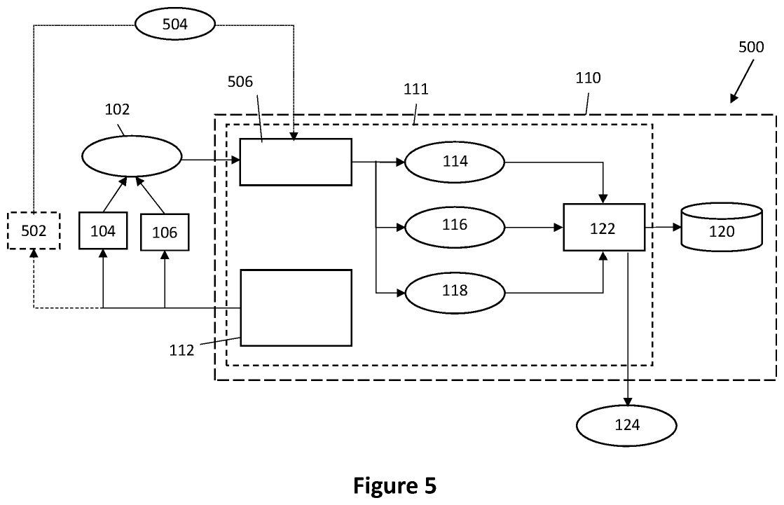

Referring to FIG. 5, the depicted system 500 is similar to the system 100 depicted in FIG. 1, and the aforementioned features and options also apply to this embodiment. The system 500 additionally includes a thermal camera 502, typically but not necessarily located between the cameras 104, 106. The thermal camera 502 will acquire a thermal reading and provide a 2D thermal image of the monitored apparatus, or a portion thereof. The thermal image data 504 is provided to the processing module 506 for processing. The processing module 506 in this embodiment performs the same algorithms as the processing module 108 discussed above, but with further processing to utilise the thermal image data 504.

In some embodiments, the 2D thermal image data 504 are “draped over” the mesh model or the point cloud. For instance, each pixel location in the thermal image is matched to a corresponding pixel location in the point cloud 216 or a corresponding node location in the mesh model 304. The thermal reading value at that pixel in the thermal image is then assigned to the corresponding point cloud data point or the corresponding node. The matching may be a direct match where the (x, y) coordinate values in the thermal image correspond with identical (x, y) coordinate values in the point cloud or mesh model. This may alternatively be a scaled match, using a difference in resolution between the images, to convert the pixel coordinates in the thermal image to the equivalent non-depth coordinate in the point cloud or mesh model. The matching may further involve applying a tolerance range to find the “nearest” match in the point cloud or mesh model for each pixel in the thermal image.

The result is a “3D” heat map (e.g., reference 306 in FIG. 3) for the monitored apparatus. From the 3D heat map, it is possible to thermally identify the monitored apparatus 10 and distinguish it from, e.g., dirt or other ground matter that does not become warm or hot. Doing so also helps to improve the accuracy of the identification process for the monitored apparatus. By comparing the heat map 306 with the expected profile (e.g., spatial shape or map) of the monitored apparatus 10, it is also possible to identify any areas that have lower than expected thermal readings—this may indicate a loss, which may be a physical loss such as a broken off or missing part, or a performance loss due to, e.g., a loss of current or power, or another loss mechanism which leads to a change in the heat reading.

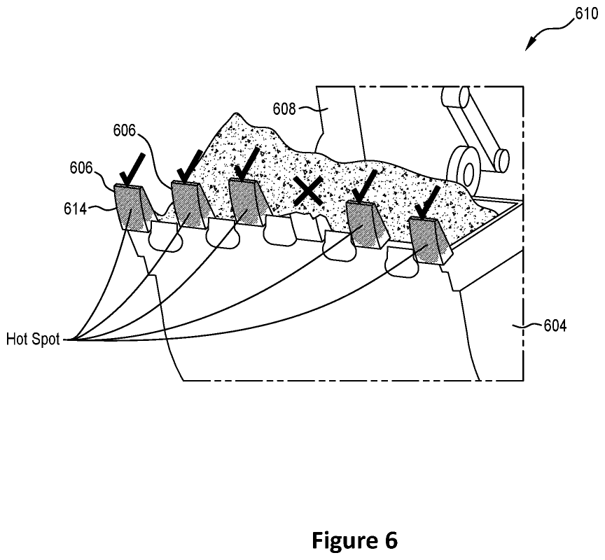

For example, FIG. 6 depicts a 3D thermal image 602 for the monitored apparatus 610, which in this case comprises a ground engaging bucket 604 having a plurality of ground engaging teeth 606, and a portion of a boom arm 608 which supports the bucket 604. The bucket 604 is also shown to have a payload. The lighter colours in the teeth indicate a higher temperature reading, as would be expected of digger teeth in operation. The heat map 602 shows five “hot spots”, i.e., local areas that have a high thermal reading, corresponding to ground engaging teeth carried by the bucket 604. Therefore, by comparing with the expected profile or pattern for the wear assembly which would carry six teeth, it can be seen that there is a physical loss of one tooth, as indicated by the “X” sign.

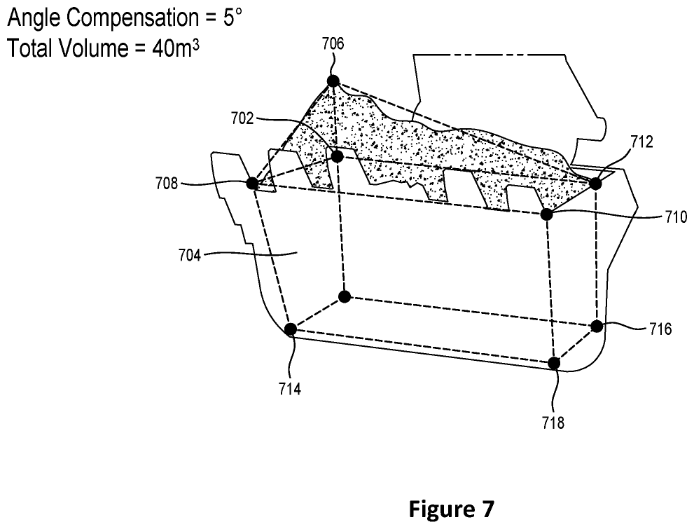

The three-dimensional model or point cloud may further be used to determine a volume of the matters contained in the bucket, i.e., the bucket payload. Referring to FIG. 7, the excavated matter 702 can be distinguished from the bucket 704 using the thermal information in the three-dimensional heat map. By identifying the 3D data points corresponding to the excavated matters and the bucket, and using their locations, it is possible to produce an estimate of the payload volume. In this example, the nodes identified include a point 706 corresponding to a top portion, such as an apex of the approximated volume of excavated matter, and corner points 708, 710, 712, 714 corresponding to the corners of the rim of bucket 704, it is possible to calculate a payload estimate. The calculation can further compensate for the angular pose of the bucket 704 for a more accurate estimate. Preferably, the calculated payload is fed-back to an operator of the apparatus, so that the operator can adjust the operation of the apparatus to get a fuller payload, if the calculated payload volume is too low. The above-mentioned volume calculation may instead be done by identifying nodes of the mesh elements between the identified mesh modes.

The wear or operational metrics mentioned above, particularly where the data are acquired and analyses made over time, can be used to generate reports of the wear or operational, or both, of the apparatus. The wear and the operational data, if both available, can further be compared, to identify any correlation between wear and the operational or efficiency of the monitored apparatus. The wear or operational profile over time can be used to predict when the apparatus may need to be serviced or repaired.

The disclosed system and method may be used in situations where the monitored apparatus is too large to be captured by one set of cameras (imaging sensing cameras only, or image sensing cameras and thermal cameras). In this case, the system may include multiple sets of cameras. The image processing module would therefore receive and process the data from the different sets of cameras.

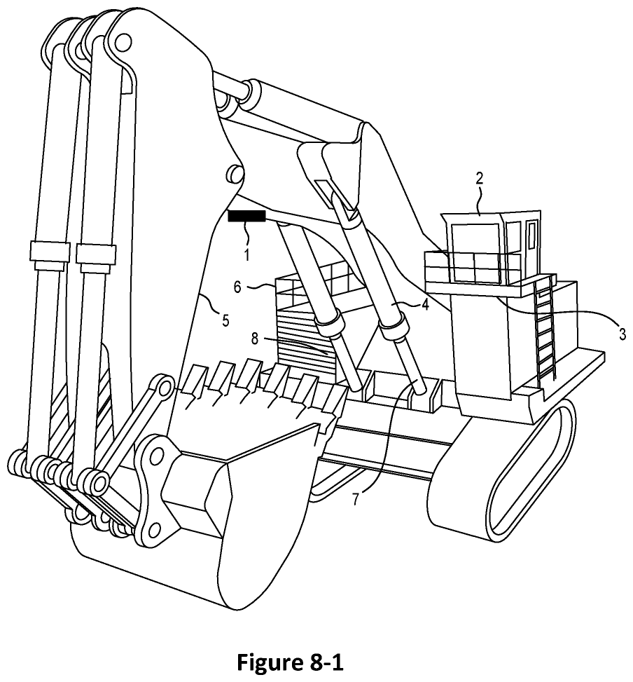

Requirements as to the locations of the cameras, as well as the camera specification, will depend on the application. For example these may depend on the apparatus being monitored. In the case of an excavation equipment where the excavation bucket is being monitored, the cameras can be mounted in one or more potential locations, non-limiting examples of which are shown in FIG. 8-1. These include locations under the boom arm of the mining equipment (locations 1 and 5), location on the driving cab (location 2), locations provided on the deck or bridge of the mining equipment where tripods can be placed (locations 3, 6, 8), locations on or at the base of the hydraulic arms (locations 4 and 7). Images acquired of the excavation bucket, from each of the eight locations marked in FIG. 8-1, are shown in FIG. 8-2.

The dimensional measurements 118 can be further analysed. For example, in the case of a wear component this allows a comparison of the determined measurements with an expected profile to determine a wear profile, or more generally a change profile. Optionally, the imaging processing algorithms 200 is also adapted to analyse a series of measurements obtained at different times, to ascertain how the apparatus is wearing or performing over time.

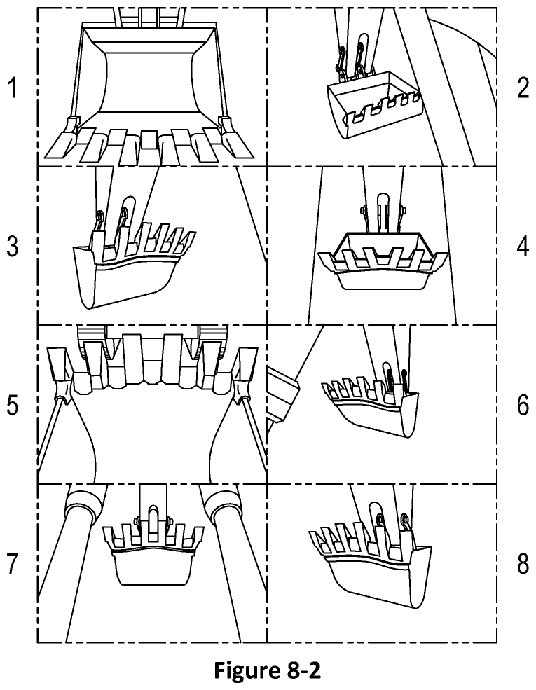

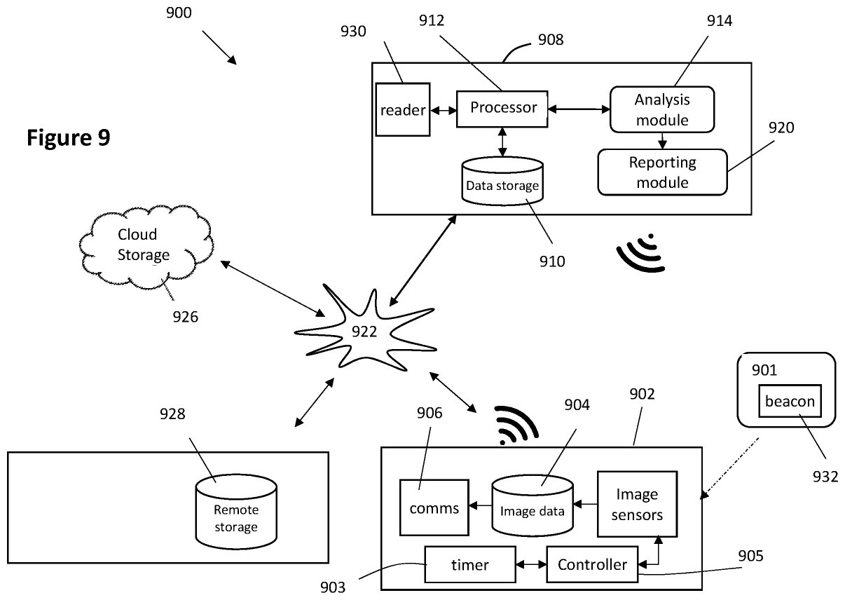

FIG. 9 is a conceptual representation of an equipment monitoring system 900 provided in accordance with an embodiment of the disclosure herein. The system 900 may be used to implement the processes mentioned above. The equipment monitoring system 900 includes at least one image sensor assembly 902, for acquiring imaging sensor data 904 of an apparatus 901 being monitored. The image sensor assembly 902 comprises a set of cameras for acquiring a corresponding set of images, and may further comprise a thermal imaging sensor in some embodiments. The thermal imaging sensor will be located so that its sensing region also includes the monitored apparatus, and preferably will overlap with the sensing regions of the image sensor assembly. A communications module 906 provided with the assembly 902 enables the image sensor data 904 to be transmitted wirelessly to a computing device 908. However, the data may be transmitted via a wired connection, in which case the communication module would not be required. The wireless communication may be long range or short range, or both may be enabled. Short range communication, such as via Bluetooth®, is preferred, if the computing device 908 is nearby. Long range communication, such as via mobile data network or WIFI, is preferred if the computing device 908 is offsite.

The image data 904 is provided to a computing device 908, which is either located near the image sensor assembly or assemblies 902, or in a remote location. The imaging sensor data 904, when received, is stored in a memory location which is accessible by a processor 912 which will process the imaging sensor data 904.

The computer readable memory for storing the imaging sensor data 904 may be provided by a data storage 910 collocated with the processor 912, as shown in FIG. 9. Alternatively it may be in data connection with the computing device 908, such as in the form of cloud storage 926 accessible over a communications network 922. Alternatively, the imaging sensor data 904 may be transmitted via a communication network 922 to a storage facility 928. The network 922 used for transmission may be a long range network 922 such as WIFI or cellular data network, or a short or medium range work. The storage facility 928 may be remotely located.

So that the processor 912 can distinguish between imaging sensor data for different monitored apparatuses, they are preferably matched to unique apparatus identifiers. For example, the processor 912 has access to a reader 930 such as a radio frequency identifier (RFID) reader, for receiving a unique ID beacon broadcast from a transmitter 932, assigned to each monitored apparatus. The imaging sensor data 904 are saved against the unique ID.

The processor 908 is configured to execute machine readable instructions 914, to perform embodiments of the processing and analysis described in the previous portions of the specification. Execution of the instructions or codes 914 will cause the server processor 908 to receive or read the imaging sensor data 904 and process it, to check whether the image data includes data associated with the monitored apparatus, and if so, determine the wear or operational information associated with the monitored apparatus.

The processor 908 may further be configured to provide control signals to the image sensor assembly or assemblies 902, to control the image acquisition. Additionally or alternatively, each image sensor assembly 902 may include a timer 903 and an onboard controller 905, to cause an automatic or configurable operation of the image sensors.

The processor 912 includes code or instruction 920 to generate a report or a notification from the results from the processing and analysis. The notification may be provided directly as an audio, visual, or audio-visual output by the computing device 908, particularly if the computing device 908 is being monitored by an administrator offsite or by an operator onsite. The processing and analysis results, or the report or notification, or both, can be stored in the data storage 910, a remote storage 928 such as a central database, or cloud-based storage 926, to be retrievable therefrom.

Alternatively, or additionally, the result may be provided as a “live” result which an administrator or an operator can access. The result is “live” in the sense that it is updated when new imaging sensor data are acquired and processed.

The system 900 thus described allows an operator or an administrator to assess the condition or operational of the apparatus, without needing to stop the operation of the apparatus to do a visual inspection in person. Aside from avoiding potential safety hazards, this also helps to reduce or avoid the down time required to visually inspect the apparatus. The condition or operational can be assessed frequently, technically to the extent allowed by the constraints placed on the computing or communication hardware. The system thus can be used to provide frequent assessments of the wear or operational profile of the monitored apparatus, and determine how these profiles change over time or are affected by specific operation conditions.

The result from the monitoring is also more accurate, retrievable, and will be automatically matched to the various parts of the monitored apparatus. The reporting algorithms may also include predictive algorithms to predict, on the basis of the wear or operational profile measured over time, when the apparatus may need to be serviced or have its component(s) replaced.

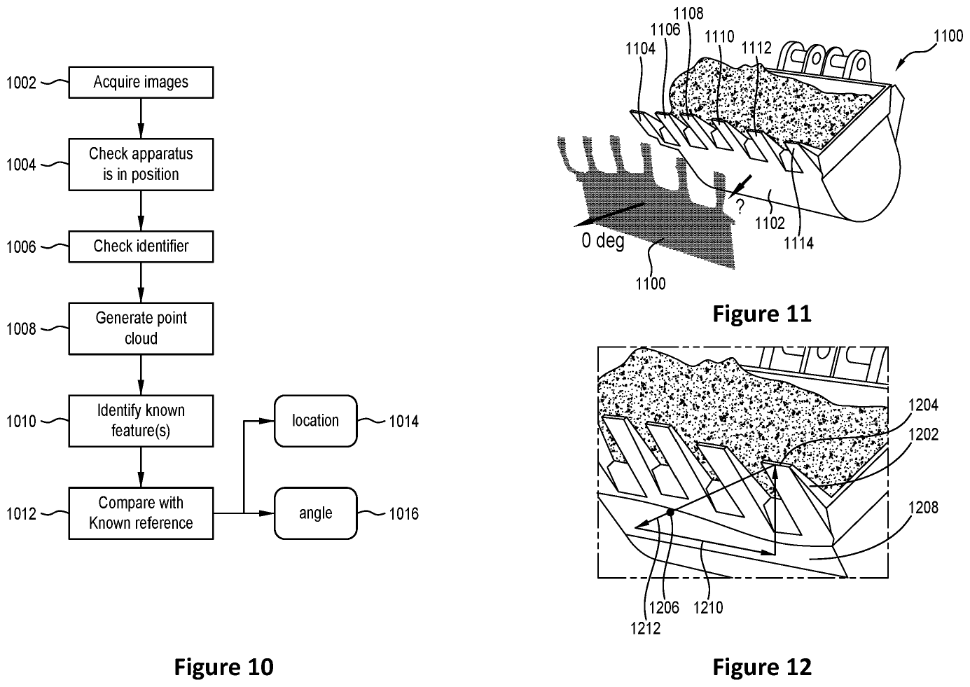

FIG. 10 depicts an example workflow to identify position and orientation the monitored apparatus from image data, in accordance with an embodiment of the disclosure. It may be used to implement the system described above.

In step 1002, an image data acquisition means acquires image data of the monitored equipment. This may be a rapid acquisition—limited by the frame rate of the image acquisition device. The image data acquisition means may be a camera arrangement.

In step 1004, algorithms are applied to the acquired images to determine whether the monitored apparatus is in a suitable position in the image frame, such that the image data of the device includes information needed for later processing, e.g., to prepare a model of the monitored apparatus, or to perform a calculation of one or more physical, operational, or performance parameters of the apparatus.

The determination of whether the monitored apparatus is in the suitable position may be done by applying object detection algorithms to detect the presence of one or more objects or features which are characteristic of the device being monitored. For instance, in the case that the monitored apparatus is a bucket of a ground engaging tool, the object being detected may include the bucket tooth. The algorithm may require that a threshold number of the objects (e.g., teeth), such as two or more, but preferably three or more, to be detectable in the image. In another example, the algorithms may require two or more different objects or detectable features in the image data. Such requirement(s) being made is used as a condition that the image data show the monitored apparatus (e.g., bucket) to be in a suitable position for later image data processing.

Potentially but not necessarily, the determination will also involve ascertaining whether the relative positioning between the detected objects are as expected if the monitored apparatus is in the suitable position.

If the algorithm determines from the image data that the monitored apparatus is not in the suitable position, the next image frame is processed. If the algorithms from the image data of a current image that the monitored apparatus is in a suitable position, further processing will occur.

The further processing may include step 1006, to determine an identifier associated with the monitored apparatus or an identifier associated with another work vehicle in range of the monitored apparatus, or both. For example, in the case that the monitored device is a ground engaging tool, the system may check for an RFID signal from a truck which is in range. This may be useful, for example, to identify the truck in which there may have been a lost tooth from the ground engaging tool. This process is an example of the identification mentioned in respect of FIG. 9.

At step 1008, the image data determined at step 1004 to show the monitored apparatus in the suitable position will be processed, to generate depth data using the stereo image data. By co-registering the depth z with the (x, y) coordinates, it is possible to build a point cloud using the (x, y, z) coordinates. An example implementation for this step is the process described above in respect of FIG. 2.

At step 1010, the point cloud data are processed to determine those data points that correspond with at least one recognizable feature or area which is expected to be visible in the image of monitored apparatus. For example, referring to FIG. 11, in the case of a bucket 1100 for a ground engaging tool, a front face model 1102 of the bucket 1100 may be used as the feature or component to be detected in the image data.

At step 1012 the detected landmark or features is compared with a known reference data or model of the landmark or feature. This allows the determination of a position 1014 and angle 1016 of the detected feature on the monitored device, and thus of the monitored device. As the point cloud data point positions are determined with reference to the image acquisition device. The absolute position of the monitored device can be determined if the location of the image acquisition device is known, for instance by using a global positioning system.

One example of how the orientation and position of the monitored apparatus may be determined is to align a known reference data of at least a portion of the monitored apparatus, to the point cloud representation of the portion.

In some examples, the reference data is a known data or model representation of the feature or area on the monitored apparatus, in which the monitored apparatus assumes a particular orientation (e.g., upright and facing directly onto the camera). The reference data may be a data presentation of a portion of the monitored apparatus, or data acquired of a target or a pattern formed using a plurality of targets attached to the bucket. The known data may be itself a 3D model which may or may not be a point cloud model. Alternatively it can be a two dimensional model such as an image data.

The alignment required to align the point cloud data corresponding to the recognized feature(s) with the reference data, or vice versa, will provide information as to the position and orientation of the 3D point cloud compared with the known representation of the apparatus as provided by the reference data.

Information such as particular area, length or angle in the recognisable feature can be computed from the 3D point cloud data, to compare with the known area, length or angle. The comparison allows for a determination of the relative misalignment between the known representation of the feature and the features as presented in the 3D point cloud. In this case, the actual reference representation itself is not required, as long as the know length, angle, area, etc, are available.

The point cloud coordinates can then be transformed to a new 3D coordinate system that aligns with the orientation of the apparatus. The coordinate system may further be scaled, if needed, so that a unit length in the new 3D coordinate system will correspond with a unit distance of the monitored apparatus.

Distance of various parts in the monitored apparatus can be determined using the point cloud data as converted into the new 3D coordinate system.

In embodiments where thermal image data are used, the thermal values may be assigned to the (x, y) coordinate values as transformed into the same coordinate system.

The algorithms may be configured to determine the data points in the point cloud corresponding to the recognizable feature or area. For example this may be done by processing the image or point cloud data to detect a characteristic shape or pattern, e.g., the crenelated shape or pattern of the wear teeth.

FIG. 11 depicts an example of reference data. In FIG. 11, the front face model 1110 includes a front wall of a bucket and the adaptors for the teeth. The teeth 1104, 1106, 1108, 1110, 1112, 1114 (or tooth adaptors) on the front face 1102 can be expected to provide a discernible crenelated shape. The front face model used to compare with the 3D point cloud data does not need to be a 3D point cloud model. For instance, 2D information can be calculated from the 3D point cloud data and then compared with a 2D front face model.

Alignment between the reference data and the 3D point cloud, or features extracted from the 3D point cloud, provides an orientation data, for transformation of the 3D coordinate system of the 3D point cloud. In FIG. 11, the depth axis, or the “z” axis of the new 3D coordinate system will align with the normal axis from the front face in the acquired 3D point cloud. The depth axis may be an axis which is normal to the front face at the mouth of the bucket, so that the depth at the front face is 0, and the depth is at its maximum at the opposite, rear face of the bucket, of the bucket. The horizontal or “x” axis will be rotated in accordance with the orientation the front face, and the vertical or “y” axis will remain vertical and orthogonal to the transformed x and z axes.

The algorithms are configured to calculate different measurements of the monitored device, to calculate physical distances between any two points (i.e., lengths) or the area of a plane bound by any three or more points (i.e., areas), or the volume bound by a plurality of points. In some embodiments, these calculations are used to create planes as estimates for various surfaces on the monitored apparatus, for simplifying length, area, or volume estimation. The calculations may be calculated using the transformed coordinates of the points, or using the original coordinates and then corresponding measurements in the transformed coordinate system determined.

For example, as shown in FIG. 12, it is possible to calculate the distance between any two points in the coordinate system using the vertical offset 1208, the horizontal offset 1210, and the depth offset 1212 between the two points. In the depicted example the two points are a top 1204 of a ground engaging tooth 1202 and the base 1206 of the shroud, for a ground engaging bucket being monitored.

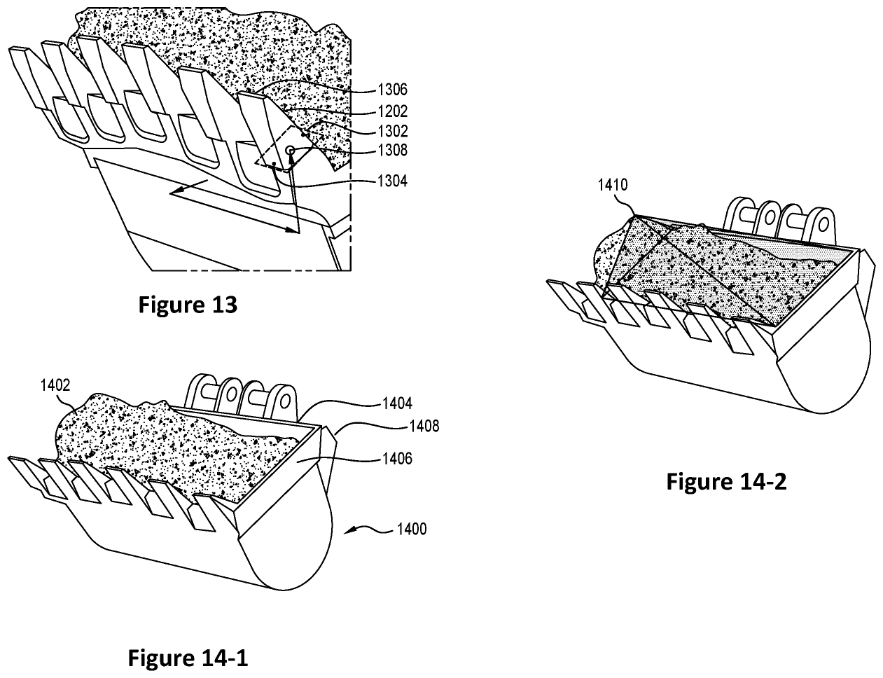

Referring to FIG. 13, in some embodiments, to calculate the length of a tooth, the algorithm(s) create an imaginary plane 1302. The imaginary plane 1302 may represent a base plane of the tooth 1202, where it is configured to be parallel to the base of the shroud or the mouth of the bucket, and incorporate a point 1304 in the point cloud that lies on the front face of the bucket and is at the base of the tooth 1202. The length for the tooth can then be measured as the distance between the plane 1302 and the tip of the tooth. For example, the distance is calculated as the distance between the plane 1302 and the point cloud data point 1306 along the tip region of the tooth which is farthest from the plane—i.e., the distance between the tip point 1306 and the point 1308 on the plane 1302, which form an orthogonal axis to the plane 1228. The creation of the imaginary plane and the calculation of distance is done for each tooth to calculate the length of each tooth.

The measured length can be compared with the known unworn length to ascertain an amount of wear, and can also be monitored over time to obtain a rate of wear. The measured length can further be compared with a threshold such that if the length is shorter than the threshold length, then a tooth loss is declared as detected.

However the imaginary plane does not need to represent a base plane of the tooth. For instance, it can be a plane which is parallel to the z-axis of the transformed 3D coordinate system, and which incorporates a landmark (e.g., a point or edge on the mouth of the bucket or a target bolted to the bucket). Each tooth will have a corresponding distance to that plane, and the corresponding distance measured can be compared with the expected distance between an unworn tooth to that plane, to ascertain wear. If the difference between the measured distance and the expected distance is greater than a threshold, a loss may be declared.

The use of imaginary planes is not required in all embodiments. For example, a distance between a detected tip of a tooth and a target attached to the bucket can be computed using the point cloud data. The computed distance can be compared with the expected distance when there is no wear in the tooth. The comparison allows the determination of an indication of wear, or even loss. As in the embodiments which make use of planes, if the difference between the measured distance and the expected distance is greater than a threshold, a loss may be declared.

In some embodiments, thermal imaging data may also be used to verify whether the point cloud data match the thermal data. For example, the image acquisition means will also include a thermal or infrared camera. The teeth of a ground engaging tool are expected to be of a higher temperature than the bucket and also the dirt and rocks. Therefore, the teeth are expected to show up in the thermal data as regions of high temperature. In a region where there are no high temperature readings, then it is expected that there will be no points belong to a useable tooth in that region. Thus, the tooth loss detected using the point cloud data may be first verified by checking whether the thermal data also indicates there is an absence of a tooth in that region. Or, the algorithms may be configured to only check the thermal data to detect tooth loss. In embodiments where the thermal image data are separately checked to improve the accuracy of loss or wear detection, the thermal image data may instead be combined with the camera image data, for instance, to create the 3D heat map mentioned in relation to FIG. 6.

Referring to FIGS. 14-1 and 14-2, the algorithms may be configured to create imaginary planes so as to calculate the volume of the payload 1402 in the bucket 1400. As conceptually shown in FIG. 14-1, the algorithms may be configured to create an imaginary plane 1404 representing a mouth of the bucket, on the basis of the size of the bucket opening which is known, and the location and the angle of the bucket which have been calculated. The plane 1404 may be set by ensuring it incorporates a detected edge 1406 of the bucket 1400 or a detected point (or node) in the point cloud which corresponds with a corner 1408 of the bucket 1400.

As shown in FIG. 14-2, the algorithms are configured to find the point cloud point 1410 corresponding to the tip of the payload, which is the farthest from the created plane 1404 representing the bucket's mouth. The volume of the portion of payload above the mouth of the bucket 1400 is estimated by calculating the volume of the pyramid formed between the payload “tip” point 1410 and the imaginary plane 1404. This can then be combined with the volume of the bucket within the mouth, which may already be known, to provide the total payload volume.

As alluded to previously in relation to FIGS. 1 and 4, the recognisable feature (i.e., landmark) may instead be a particular arrangement of targets attached to the ground engaging tool.

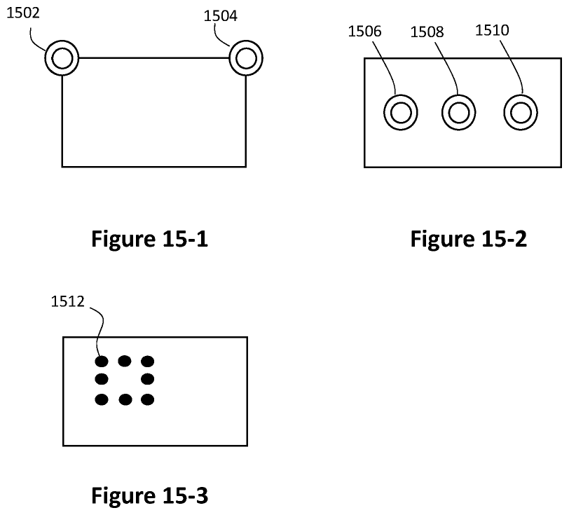

FIGS. 15-1 to 15-2 schematically depicts two examples of one or more targets being applied to the monitored apparatus. In these examples, the targets are shown to have a concentric circle pattern. However, targets having other distinctive shapes or patterns may be used, as long as they can be detected using image processing techniques. As shown in Figure targets 1502, 1504 are applied to corners of the monitored apparatus to make the corner points more visible. In FIG. 15-2, targets 1506, 1508, 1510 are arranged to form a linear line. FIG. 15-3 depicts an alternative embodiment, where the targets 1512 are arranged to form a distinctive pattern, e.g., a square. As can be seen from FIGS. 15-1 to 15-3, the targets may themselves be visually distinctive and detectable in the image processing, or form a pattern which is visually distinctive and detectable in the image processing, or both.

Angular or dimensional calculations can be performed to determine the relative angle between the point cloud data points corresponding to the recognizable area or feature, and the known reference, as discussed previously. The point cloud coordinates can then be transformed to a new 3D coordinate system to account for the orientation of the monitored device, the scale of the monitored device (e.g., due to distances appearing smaller if the apparatus is farther away), or both. As can be appreciated, physical parameters may instead calculated using the original 3D coordinate system, and then adjusted to compensate for the orientation of the monitored apparatus, and the apparent scale of the apparatus due to its distance from the cameras.

Variations and modifications may be made to the parts previously described without departing from the spirit or ambit of the disclosure.

For example, in the above examples where the monitored apparatus is a bucket having ground engaging teeth, the analysis provided by the system determines a wear profile in relation to the ground engaging teeth. However, the system may also be used to determine a wear profile for another component, such as the teeth adapter, the shroud, or the bucket itself, or another part where wear is expected even if it is not ground engaging.

Also, while the illustrative examples pertain to the monitoring of an apparatus of a mining apparatus, such as an excavation equipment or ground digger, the system has application to other types of apparatuses.

In the above embodiments, image data acquired by two cameras or image sensors are analysed. However, the embodiments may make use of images from three or more cameras or image sensors, and to carry out the aforementioned analyses and calculations on the basis of the disparity between any two out of the three or more cameras. A plurality of disparity data, each calculated from a different selection of two out of the three or more cameras may be used. This, for example, may increase the accuracy of the calculations. As a further option to the embodiments described, there may be two or more sub-sets of multiple cameras, each sub-set being located so as to acquire image data of the apparatus from a different angle, and for the aforementioned analyses and processes to be performed on the image data acquired by each sub-set of cameras or image sensors. Of course, even in embodiments with more than two cameras, it is possible to use only the image data from two cameras, as long as the two cameras have sufficiently overlapping fields of view so that a determination of the position of the apparatus relative to the cameras can be made.

Unless specified to the contrary, the features of the process mentioned in respect of the embodiment shown in FIG. 10 are applicable to other embodiments. Further, while FIG. 10 illustrates an example where the vision processing is applied to image data of a ground engaging bucket, the same strategy can be generalised to the monitoring of other types of equipment.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

1-30. (canceled)

31. A method for determining a physical or operational characteristic of a ground engaging apparatus, comprising:
acquiring two-dimensional image data of at least a portion of the apparatus, the at least portion having one or more targets thereon, the two-dimensional image data providing stereo image data of the at least portion, wherein the one or more targets are captured in the two-dimensional image data;
determining a position of the one or more targets relative to image sensors used to acquire the two-dimensional image data; and
calculating the physical or operational characteristic using the determined position of the one or more targets and the stereo image data of the at least portion of the ground engaging apparatus.

32. The method of claim 31, comprising constructing a three-dimensional representation of the at least portion of the ground engaging apparatus using the two-dimensional image data.

33. The method of claim 32, wherein determining position of the one or more targets comprises comparing data in relation to the one or more targets in the three-dimensional representation with a known reference data.

34. The method of claim 32, wherein the comparison comprises determining a scaling factor or angular adjustment, or both, required to align the known reference data and data in relation to the one or more targets in the three-dimensional representation.

35. The method of claim 34, comprising applying the scaling factor or angular adjustment, or both, to the three-dimensional representation of the at least portion of the apparatus.

36. The method of claim 31, wherein the one or more targets are attached to a portion of the apparatus which is not a wear part.

37. The method of claim 36, wherein the one or more targets have or form a pattern.

38. The method of claim 31, wherein the three-dimensional representation is a three-dimensional point cloud model or a mesh model.

39. The method of claim 38, wherein the physical or operational characteristic is or is determined from at least one distance, area, or volume measurement.

40. The method of claim 39, including calculating the volume measurement for a payload volume of the apparatus, by combining a known physical volume of the apparatus and a volume associated with an operation of the apparatus estimated using the three-dimensional representation.

41. The method of claim 31, including storing a plurality of physical or operational characteristics determined over time.

42. The method of claim 41, including predicting a service or maintenance requirement for the apparatus on the basis of the plurality of physical or operational characteristics determined over time.

43. The method of claim 41, including using the plurality of physical or operational characteristics to determine a historical or statistical profile of the physical or operational characteristics.

44. The method of claim 31, wherein the at least one physical or operational characteristic provides a measure of wear, loss or damage to the apparatus.

45. The method of claim 31, including obtaining a two-dimensional thermal image of the apparatus.

46. The method of claim 45, including assigning thermal readings in the two-dimensional thermal image to corresponding locations in the three-dimensional representation of the at least portion of the apparatus.

47. The method of claim 46, including identifying a location of loss using the three-dimensional heat map.

48. A system for assessing a wear or operational characteristic of a ground engaging apparatus, the system comprising:
a plurality of imaging sensors, configured to acquire stereo images of the apparatus, or a part thereof;
a computer readable memory for storing the image data of the acquired stereo images;
a computing device comprising a processor, the processor being in data communication with the computer readable memory, the processor being configured to execute computer readable instructions to:
cause the imaging sensors to acquire two-dimensional image data of at least a portion of the apparatus, the at least portion having one or more targets thereon, the two-dimensional image data providing stereo image data of the at least portion, wherein the one or more targets are captured in the two-dimensional image data,
determine a position of the one or more targets relative to image sensors used to acquire the two-dimensional image data; and
calculate a physical or operational characteristic using the determined position of the one or more targets and the stereo image data of the at least portion of the ground engaging apparatus.

49. The system of claim 48, further including a thermal sensor, collocated with at least two of the image sensors.

50. A mining or excavation equipment comprising:
a ground engaging assembly comprising a plurality of wear members;
a boom arm for supporting the ground engaging assembly; and
a system for assessing a wear or operational characteristic of the ground engaging assembly, the system comprising:
a plurality of imaging sensors configured to acquire stereo images of the ground engaging assembly or a part thereof, that capture the one or more targets;
a computer readable memory for storing the image data of the acquired stereo images;
a determination module configured to determine a position of the one or more targets relative to image sensors; and
a calculation module configured to calculate a physical or operational characteristic of one or more of the wear members using the determined position of the one or more targets and the stereo image data of the at least portion of the ground engaging apparatus.

51. The mining or excavation equipment of claim 50, wherein the imaging sensors are mounted on an underside of the boom arm.

52. The mining or excavation equipment of claim 50, wherein the image sensor assembly is mounted on a boom arm of the mining or excavation equipment.
